(19) United States
(12) Patent Application Publication
(10) Pub. No.: US 2013/0027542 A1
(43) Pub. Date: Jan. 31, 2013

(54) ELECTRONIC COMPONENT CARRYING DEVICE AND ELECTRONIC COMPONENT CARRYING METHOD

(71) Applicant: Masakuni SHIOZAWA, Chino (JP)

(72) Inventor: Masakuni SHIOZAWA, Chino (JP)

(73) Assignee: SEIKO EPSON CORPORATION, Tokyo (JP)

(21) Appl. No.: 13/546,308

(22) Filed: Jul. 11, 2012

(30) Foreign Application Priority Data
Jul. 26, 2011 (JP) 2011-162900

(51) Int. Cl. H04N 7/18

(52) U.S. Cl. 348/87; 348/E07.085

(57) ABSTRACT

A first imaging unit forming a first image by imaging a first surface of an electronic component having the first surface and a second surface, a second imaging unit forming a second image by imaging the second surface, a grasping unit grasping the electronic component, a movable unit moving the grasping unit, and a control unit detecting a position of the first surface using the first image, detecting a position of the second surface using the second image, and controlling the grasping unit and the movable unit are provided. The grasping unit brings relative positions between the grasping unit and the first surface into predetermined relative positions and grasps the electronic component using position information of the first surface detected by the control unit, and the movable unit moves the second surface to a predetermined position using position information of the second surface detected by the control unit.

### BACKGROUND

1. Technical Field

The present invention relates to an electronic component carrying device and an electronic component carrying method, and specifically relates to alignment of electronic components.

2. Related Art

When electronic components are inspected, probes are brought into contact with electrodes of the electronic components and electric signals are transmitted. The density of the electrodes becomes higher with higher density of the electronic components, and it is necessary to arrange the electronic components with high positional accuracy with respect to the probes. A device that carries the electronic components into contact with the probes is an electronic component carrying device. Further, in the electronic component carrying device, accurate contact of the electronic components with the probes is particularly important for maintenance of proper inspection.

Recently, electronic components have been downsized and highly integrated and electrodes have been provided on both sides of the lower surfaces and the upper surfaces of the electronic components. Further, objects to be inspected have often included electronic components having structures in which electronic components have other electronic components stacked on their upper surfaces. The electronic components having the structures are referred to as “package on package (POP)”. Also, in the electronic components having the stacking structures, electrodes have been respectively provided on both sides of the lower surfaces and the upper surfaces of the electronic components.

Patent Document 1 (International Patent WO 2003/075023 Pamphlet) discloses an example of a technology of accurately connecting electrodes of electronic components having fine intervals to contact terminals of inspection sockets. According to the document, a restraint/non-restraint switching mechanism is provided in a grasp-side arm that grasps electronic components and the grasped electronic components are imaged from below. Further, positional correction of the electronic components is performed based on the imaging result by position correcting means including another unit than the grasp-side arm, and the electronic components are fixed with respect to the grasp-side arm in corrected positions by the restraint/non-restraint switching mechanism. Then, the electrodes of the electronic components in the fixed positions are brought into contact with the contact terminals of the inspection sockets. Thereby, the accuracy of the positional relationship between the inspection head and the electronic components may be maintained higher, and thus, the inspection accuracy of the electronic components for the inspection sockets by the inspection head may be maintained higher.

When there are terminals on both sides of the upper surfaces and the lower surfaces of the electronic components, the relative positions of the terminals on both sides may be shifted depending on the condition of the manufacturing process. Therefore, it is necessary to respectively bring the terminals on both sides of the upper surfaces and the lower surfaces of the electronic components in alignment with the terminal positions of the electronic components. Accordingly, an electronic component carrying device of grasping the relative positions with respect to the first surfaces of the electronic components with high positional accuracy and further moving the second surfaces to predetermined positions with high positional accuracy has been desired.

### SUMMARY

An advantage of some aspects of the invention is to solve at least a part of the problems described above, and the can be implemented as the following forms or application examples.

### Application Example 1

This application example is directed to an electronic component carrying device including an imaging unit that forms a first image by imaging a first surface of an electronic component having the first surface and a second surface and forms a second image by imaging the second surface, a grasping unit that grasps the electronic component, a movable unit that moves the grasping unit, and a control unit that detects a position of the first surface using the first image, detects a position of the second surface using the second image, and controls the grasping unit and the movable unit, wherein the grasping unit brings relative positions between the grasping unit and the first surface into predetermined relative positions and grasps the electronic component using information of the position of the first surface detected by the control unit, and the movable unit moves the second surface to a predetermined position using information of the position of the second surface detected by the control unit.

According to the application example, the control unit controls the imaging unit and the imaging unit images the first surface of the electronic component and forms the first image. The control unit detects the position of the first surface using the first image. Further, the control unit controls the movable unit and the movable unit moves the grasping unit. Furthermore, the control unit controls the grasping unit and the grasping unit grasps the electronic component. In this regard, the control unit allows the grasping unit to grasp the electronic component so that the relative positions between the grasping unit and the first surface may be the predetermined relative positions. The control unit detects the position of the first surface for grasping, and thus, the grasping unit may grasp the relative positions between the grasping unit and the first surface in alignment with high positional accuracy.

The control unit controls the imaging unit and the imaging unit images the second surface of the electronic component and forms the second image. The control unit recognizes the position of the second surface using the second image. Further, the control unit controls the operation of the grasping unit and moves the second surface to the predetermined position. The control unit detects the position of the second surface for moving, and thus, may move the second surface to the predetermined position with high positional accuracy. Therefore, the electronic component carrying device may grasp the relative positions between the grasping unit and the first surface with high positional accuracy, and further moves the second surface to the predetermined position with high positional accuracy.

### Application Example 2

This application example is directed to the electronic component carrying device according to the above application example, wherein the imaging unit images the grasping unit, the control unit detects a position of the grasping unit using an image of the grasping unit, the grasping unit brings the relative positions between the first surface and itself into the predetermined relative positions and grasps the electronic component using information of the position of the grasping unit detected by the control unit.

According to this application example, the imaging unit images the grasping unit. The control unit detects the position of the grasping unit in addition to that of the first surface. Therefore, when the position of the grasping unit is changed with respect to the position of the grasping unit that has been recognized by the control unit, the electronic component may be grasped in response to the changed position.

### Application Example 3

This application example is directed to the electronic component carrying device according to the above application example, wherein the imaging unit images a location to move as a location to move the electronic component, the control unit detects a position of the location to move using an image of the location to move, and the grasping unit moves the second surface to the location to move using information of the position of the location to move detected by the control unit.

According to this application example, the imaging unit images the location to move the electronic component. The control unit recognizes the position of the location to move of the electronic component. Therefore, even when the position of the location to move is changed with respect to the position of the location to move that has been recognized by the control unit, the electronic component may be moved in response to the changed position.

### Application Example 4

This application example is directed to the electronic component carrying device according to the above application example, wherein the imaging unit includes a first imaging unit that images the first surface and a second imaging unit that images the second surface.

According to this application example, the first imaging unit images the first surface and the second imaging unit images the second surface. Therefore, the first imaging unit may be provided in the location where to easily image the first surface and the second imaging unit may be provided in the location where to easily image the second surface. Therefore, the first surface and the second surface may be easily imaged.

### Application Example 5

This application example is directed to an electronic component carrying method of carrying an electronic component having a first surface and a second surface grasped by a grasping unit. The method includes imaging the first surface and computing position information of the first surface, bringing relative positions between the grasping unit and the first surface into predetermined relative positions and grasping the electronic component using the position information of the first surface, imaging the second surface and computing position information of the second surface, and moving the second surface to a predetermined position using the position information of the second surface.

According to this application example, the first surface is imaged and the position information of the first surface is computed. Further, the relative positions between the grasping unit and the first surface are brought into the predetermined relative positions and the electronic component is grasped using the position information of the first surface. Therefore, the grasping unit may grasp the relative positions between the grasping unit and the first surface in alignment with high positional accuracy. Further, the second surface is imaged and the position information of the second surface is computed. Furthermore, the second surface may be moved to the predetermined position using the position information of the second surface. Therefore, the second surface may be moved to the predetermined position with high positional accuracy. As a result, the relative positions between the grasping unit and the first surface may be grasped with high positional accuracy, and further, the second surface may be moved to the predetermined location with high positional accuracy.

### Application Example 6

This application example is directed to the electronic component carrying method according to the above application example, which further includes, before grasping the electronic component, imaging the grasping unit and computing position information of the grasping unit, and bringing the relative positions between the grasping unit and the first surface into the predetermined relative positions and grasping the electronic component using the position information of the grasping unit in addition to the position information of the first surface.

According to this application example, the grasping unit is imaged and the position information of the grasping unit is computed in addition to that of the first surface. Therefore, even when the position of the grasping unit is changed with respect to the recognized position of the grasping unit, the electronic component may be grasped in response to the changed position of the grasping unit.

### Application Example 7

This application example is directed to the electronic component carrying method according to the above application example, which further includes, before moving the second surface, imaging a location to move as a location to move the electronic component, and computing position information of the location to move, and moving the second surface to a position of the location to move using the position information of the location to move in addition to the position information of the second surface.

According to this application example, the location to move the electronic component is imaged and the position information of the location to move the electronic component is computed. Therefore, even when the recognized position of the location to move is changed, the electronic component may be moved in response to the changed position of the location to move.

### BRIEF DESCRIPTION OF THE DRAWINGS

The invention will be described with reference to the accompanying drawings, wherein like numbers reference like elements.

FIG. 1A is a schematic side view showing a structure of an electronic component and FIGS. 1B and 1C are general perspective views showing the structure of the electronic component according to the first embodiment.

FIG. 2 is a general perspective view showing a configuration of electronic component inspection equipment.

FIG. 3A is a schematic side sectional view showing a structure of a grasping unit, FIG. 3B is a schematic bottom view showing the grasping unit, FIG. 3C is a schematic top view showing a structure of an inspection table, and FIG. 3D is a schematic side sectional view showing the inspection table.

FIG. 4 is an electrical control block diagram of the electronic component inspection equipment.

FIG. 5 is a flowchart showing an inspection operation.

FIGS. 6A to 6D are diagrams for explanation of an inspection method in the inspection operation.

FIGS. 7A to 7C are diagrams for explanation of the inspection method in the inspection operation.

FIGS. 8A to 8C are diagrams for explanation of the inspection method in the inspection operation.

FIG. 9 is a flowchart showing an inspection operation according to the second embodiment.

FIGS. 10A and 10B are diagrams for explanation of an inspection method in an inspection operation.

FIGS. 11A and 11B are diagrams for explanation of the inspection method in the inspection operation.

FIGS. 12A to 12C are diagrams showing inspection equipment of electronic components according to the third embodiment.

### DESCRIPTION OF EXEMPLARY EMBODIMENTS

In the embodiments, characteristic examples of electronic component inspection equipment including a characteristic electronic component carrying device that carries and positions electronic components and an electronic component carrying method of carrying electronic components using the electronic component carrying device will be explained. As below, working examples will be explained with reference to the drawings. The respective members in the respective drawings are shown indifferent scales with respect to each member for recognizable sizes in the respective drawings.

### First Embodiment

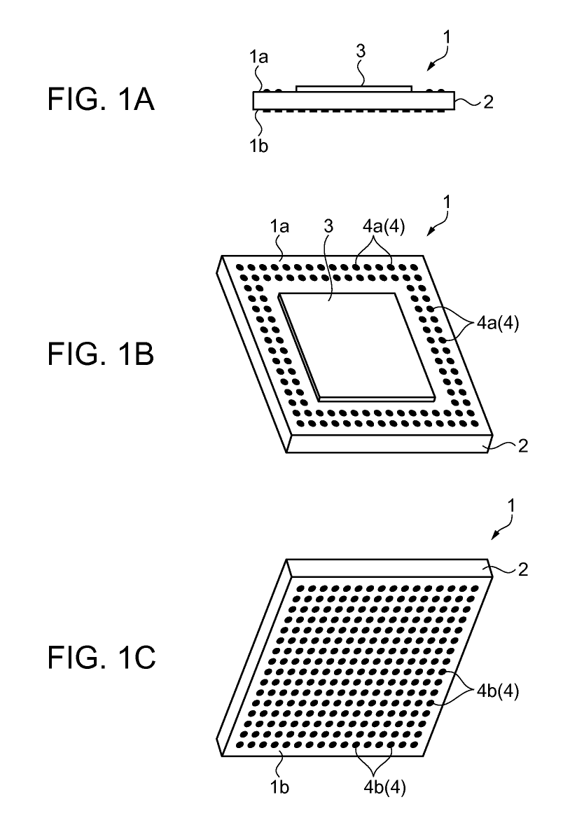

An electronic component carrying device according to the first embodiment and electronic component inspection equipment will be explained according to FIGS. 1A to 8C. FIG. 1A is a schematic side view showing a structure of an electronic component and FIGS. 1B and 1C are general perspective views showing the structure of the electronic component. FIG. 1B shows the surface on which a semiconductor device has been formed, and FIG. 1C shows the surface on which only electrodes have been formed.

As shown in FIGS. 1A to 1C, an electronic component 1 includes a square substrate 2, and a square semiconductor chip 3 is provided on a first surface 1a of the substrate 2. On the first surface 1a, first electrodes 4a surround the semiconductor chip 3. The first electrodes 4a are arranged in two rows. In the substrate 2, the surface opposite to the first surface 1a is a second surface 1b. On the second surface 1b, second electrodes 4b are arranged in a lattice pattern. Within the substrate 2, a wiring layer and an insulating layer are stacked, and the semiconductor chip 3 is connected to the electrodes 4 formed by the first electrodes 4a and the second electrodes 4b via wiring in the wiring layer.

For example, the electronic component 1 is one of downsized and highly-integrated components, and may be an electronic component in which plural electronic devices are stacked. The electronic component 1 may have a structure in which the electrodes are connected to the first electrodes 4a of the first surface 1a (POP: package on package). The semiconductor chip 3 is not particularly limited, but may be a silicon chip or resin-molded. Further, the size of the semiconductor chip 3 is not particularly limited, but a small chip may be employed. In the embodiment, for example, a chip with one side of 2 mm or a chip with a thickness of 0.3 (mm) is employed. As an example of a small and thin IC chip, a WLCSP (Wafer Level Chip Size Package) or the like may be cited. The outer shape of the electronic component 1 having the downsized semiconductor chip 3 has been downsized and miniaturization with shorter terminal intervals of the first electrodes 4a and the second electrodes 4b has been promoted.

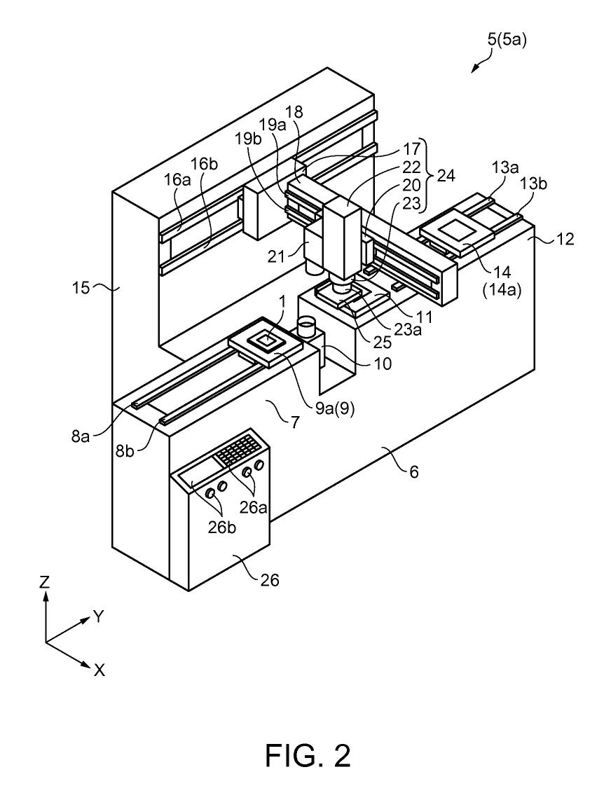

FIG. 2 is a general perspective view showing a configuration of electronic component inspection equipment. As shown in FIG. 2, electronic component inspection equipment 5 includes a base 6 having a rectangular parallelepiped shape. The longitudinal direction of the base 6 is referred to as “Y direction” and the direction orthogonal to the Y direction in the horizontal plane is referred to as “X direction” . Further, the vertical direction is referred to as “−Z direction”.

On the base 6, a feeding device 7 is provided on the left side in the drawing. On the upper surface of the feeding device 7, a pair of guide rails 8a, 8b extending in the Y direction are projected over the entire width in the Y direction of the feeding device 7. A stage 9 including a direct-acting mechanism is mounted on the pair of guide rails 8a, 8b. The direct-acting mechanism of the stage 9 is a direct-acting mechanism including a linear motor extending in the Y direction along the guide rails 8a, 8b, for example. Further, when a drive signal corresponding to a predetermined number of steps is input to the linear motor in the direct-acting mechanism, the linear motor moves forward or backward, and the stage 9 moves forward or backward along the Y direction by the amount corresponding to the number of steps. The surface of the stage 9 directed toward the Z direction is a mounting surface 9a, and the electronic component 1 is mounted on the mounting surface 9a. A suction substrate chuck mechanism is provided on the stage 9. Further, the substrate chuck mechanism fixes the electronic component 1 to the mounting surface 9a.

On the base 6, a second imaging unit 10 as an imaging unit is provided at the Y direction side of the feeding device 7. The second imaging unit 10 includes an electrical circuit substrate on which a CCD (Charge Coupled Devices) device that converts received light into an electric signal etc., an objective lens having a zoom mechanism, an epi-illumination device, and an automatic focusing mechanism. Thereby, when the electronic component 1 is positioned in a location opposed to the second imaging unit 10, the second imaging unit 10 can image the electronic component 1. Further, the second imaging unit 10 can take an image without blur by imaging after irradiating the electronic component 1 with light for focusing.

On the base 6, an inspection table 11 is provided at the Y direction side of the second imaging unit 10. The inspection table 11 is a jig for transmission and reception of electric signals at inspection of the electronic component 1.

On the base 6, a removing device 12 is provided at the Y direction side of the inspection table 11. On the upper surface of the removing device 12, a pair of guide rails 13a, 13b extending in the Y direction are projected over the entire width. A stage 14 including a direct-acting mechanism is mounted on the pair of guide rails 13a, 13b. The direct-acting mechanism of the stage 14 may use the same mechanism as the direct-acting mechanism of the feeding device 7. Further, the stage 14 moves forward or backward along the guide rails 13a, 13b. The surface of the stage 14 directed toward the Z direction is a mounting surface 14a, and the electronic component 1 is mounted on the mounting surface 14a.

A support 15 having a nearly rectangular parallelepiped shape is provided in the −X direction of the base 6. The support 15 has a shape higher than the base 6 in the Z direction. On the surface directed toward the X direction in the support 15, a pair of guide rails 16a, 16b extending in the Y direction are projected over the entire width in the Y direction of the support 15. A Y stage 17 including a direct-acting mechanism moving along the pair of guide rails 16a, 16b is mounted at the X direction side of the pair of guide rails 16a, 16b. The direct-acting mechanism of the Y stage 17 may use the same mechanism as the direct-acting mechanism of the feeding device 7. Further, the Y stage 17 moves forward or backward along the guide rails 16a, 16b.

On the surface directed toward the X direction in the Y stage 17, an arm part 18 having a prismatic column shape extending in the X direction is provided. On the surface directed toward the −Y direction in the arm part 18, a pair of guide rails 19a, 19b extending in the X direction are projected over the entire width in the X direction of the arm part 18. An X stage 20 including a direct-acting mechanism moving along the pair of guide rails 19a, 19b is mounted at the −direction side of the pair of guide rails 19a, 19b. The direct-acting mechanism of the X stage 20 may use the same mechanism as the direct-acting mechanism of the feeding device 7. Further, the X stage 20 moves forward or backward along the guide rails 19a, 19b.

On the X stage 20, a first imaging unit 21 as the imaging unit and a Z moving device 22 are provided. The first imaging unit 21 has the same structure and function as those of the second imaging unit 10. Further, the first imaging unit 21 and the second imaging unit 10 forms the imaging unit. The Z moving device 22 includes a direct-acting mechanism inside and may move a Z stage upward and downward. Further, a rotating device 23 is connected to the Z stage. The Z moving device 22 may move the rotating device 23 upward and downward in the Z direction. The direct-acting mechanism of the Z moving device 22 may use the same mechanism as the direct-acting mechanism of the feeding device 7.

The rotating device 23 includes a rotational shaft 23a and a grasping unit 25 is connected to the rotational shaft 23a. Thereby, the rotating device 23 may rotate the grasping unit 25 around an axis in the Z direction. The rotating device 23 is formed by a combination of a step motor or servo motor and a decelerator, and rotates the rotational shaft 23a to a predetermined angle. The motor type of the servo motor is not particularly limited, but an AC motor, a DC motor, a coreless motor, an ultrasonic motor, or the like may be used. In the embodiment, for example, an ultrasonic motor is employed. The Y stage 17, the X stage 20, the Z moving device 22, the rotating device 23, etc. form a movable unit 24.

A control device 26 as a control unit is provided at the X direction side of the base 6. The control device 26 has a function of controlling the operation of the electronic component inspection equipment 5. Further, the control device 26 has a function of inspecting the electronic component 1. The control device 26 includes an input device 26a and an output device 26b. The input device 26a includes a keyboard, an input connector, etc. for input of instructions of an operator in addition to signals and data. The output device 26b includes output connectors etc. for output to a display device and an external device, and outputs signals and data to other devices. In addition, the device transmits the status of the electronic component inspection equipment 5 to the operator.

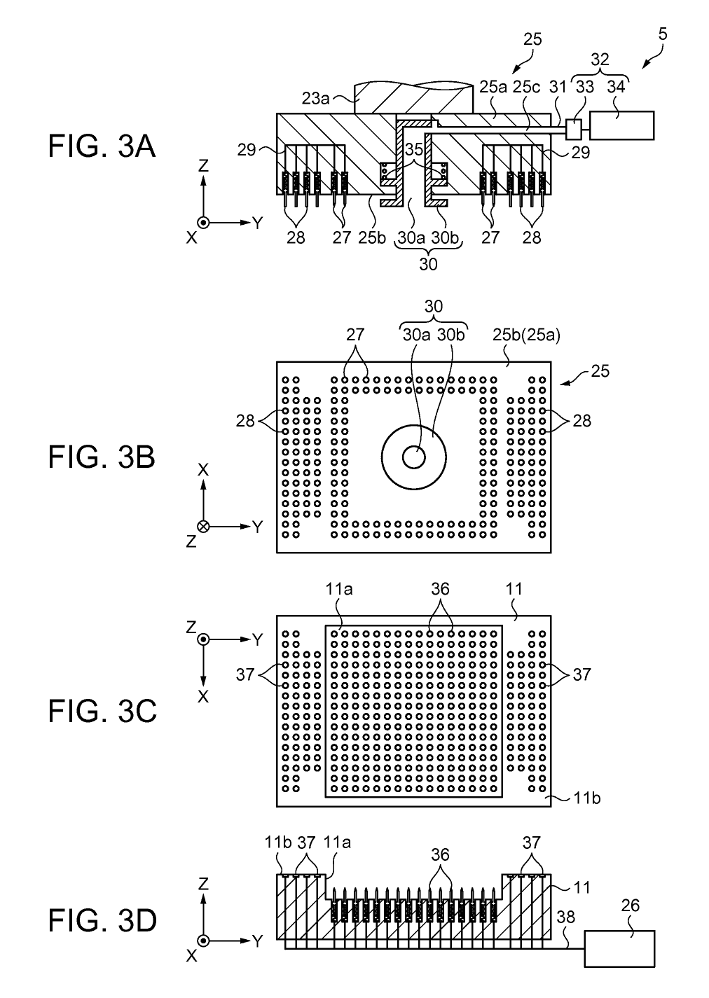

FIG. 3A is a schematic side sectional view showing a structure of the grasping unit, and FIG. 3B is a schematic bottom view showing the grasping unit. As shown in FIGS. 3A and 3B, the grasping unit 25 has a main body part 25a having a rectangular parallelepiped shape. The main body part 25a is connected to the rotational shaft 23a at the Z direction side. The surface at the −Z side of the main body part 25a is a grasping surface 25b as a surface at the side of grasping the electronic component 1. On the grasping surface 25b, first probes 27 are arranged in a square frame. The first probes 27 are in the same arrangement as that of the first electrodes 4a of the electronic component 1. Therefore, when the grasping surface 25b is superimposed on the first surface 1a of the electronic component 1, each first probe 27 contacts one first electrode 4a. The first probe 27 has a movable needle and a spring that urges the movable needle in the −Z direction. When the grasping surface 25b of the grasping unit 25 is pressed against the first surface 1a of the electronic component 1, the first probes 27 electrically contact the first electrodes 4a with low contact resistance.

A group of second probes 28 are arranged at both sides in the Y direction of the square formed by the first probes 27. The first probes 27 and the second probes 28 are provided in the same number and electrically connected by wires 29 in one-to-one relationships. Thereby, the signals input and output from the first electrodes 4a of the electronic component 1 may be input and output from the second probes 28 via the first probes 27.

A suction unit 30 is provided at the center of the grasping surface 25b. The suction unit 30 has a nearly cylindrical shape and a channel 30a for flowing the air is provided inside of the suction unit 30. A channel 25c that communicates with the channel 30a is provided in the main body part 25a of the grasping unit 25. The channel 25c is connected to a suction device 32 via a pipe 31.

The suction device 32 includes an electromagnetic valve 33, a vacuum device 34, etc. The vacuum device 34 includes a vacuum pump and a decompression tank for suction of the air. The electromagnetic valve 33 switches the valve in response to an input electric signal. Thereby, the pressure in the channel 30a of the suction unit 30 may be switched between the decompression state and the atmospheric state.

A flat suction surface 30b is formed in the XY direction at the −Z side of the suction unit 30. The suction surface 30b is brought into contact with the semiconductor chip 3 of the electronic component 1 and the suction device 32 suctions the air from the channel 30a. Thereby, the interior of the channel 30a is decompressed and the electronic component 1 is suctioned by the suction unit 30.

Within the main body part 25a, a spring 35 that urges the suction unit 30 in the −Z direction is provided. Further, the suction unit 30 is movable in the Z direction. Thereby, under the condition that the first probes 27 and the first electrodes 4a are separated, the suction unit 30 may suction the electronic component 1 to the suction surface 30b. Therefore, the suction unit 30 may suction the electronic component 1 without being affected by the first probes 27. Then, by pressing the grasping unit 25 against the electronic component 1, the grasping unit 25 may bring the first probes 27 into the first electrodes 4a.

FIG. 3C is a schematic top view showing a structure of the inspection table, and FIG. 3D is a schematic side sectional view showing the inspection table. As shown in FIGS. 3C and 3D, the inspection table 11 has the rectangular parallelepiped shape and a square recess part 11a on the surface at the Z direction side. The size of the recess part 11a as seen in the XY plan view is larger than the size of the electronic component 1 in the planar direction, and the operator may insert the electronic component 1 into the recess part 11a.

Third probes 36 are arranged in a lattice pattern on the bottom of the recess part 11a. The third probes 36 have the same structure as the first probes 27, and have the same arrangement as the second electrodes 4b of the electronic component 1. Therefore, when the recess part 11a is superimposed on the second surface 1b of the electronic component 1, each third probe 36 contacts one second electrode 4b. Further, when the second surface 1b of the electronic component 1 is pressed against the recess part 11a of the inspection table 11, the third probes 36 electrically contact the second electrodes 4b with low contact resistance.

The third probes 36 of the inspection table 11 are electrically connected to the control device 26 by wires 38. Therefore, the control device 26 outputs electric signals to the second electrodes 4b of the electronic component 1 via the third probes 36 of the inspection table 11. The electric signals output by the electronic component 1 are input to the control device 26 via the second electrodes 4b and the third probes 36.

Relay terminals 37 are arranged on an upper surface 11b of the inspection table 11. The arrangement of the relay terminals 37 is the same as the arrangement of the second probes 28 in the grasping unit 25. Further, the number of the relay terminals 37 is the same as the number of the second probes 28 in the grasping unit 25. Therefore, by superimposing the grasping unit 25 on the inspection table 11, the second probes 28 and the relay terminals 37 are electrically connected in one-to-one relationships.

The relay terminals 37 of the inspection table 11 are electrically connected to the control device 26 via wires 38. Therefore, the control device 26 outputs electric signals to the first electrodes 4a of the electronic component 1 via the relay terminals 37 of the inspection table 11 and the second probes 28 and the first probes 27 of the grasping unit 25. The electric signals output by the electronic component 1 are input to the control device 26 via the first electrodes 4a, the first probes 27, the second probes 28, and the relay terminals 37 of the inspection table 11.

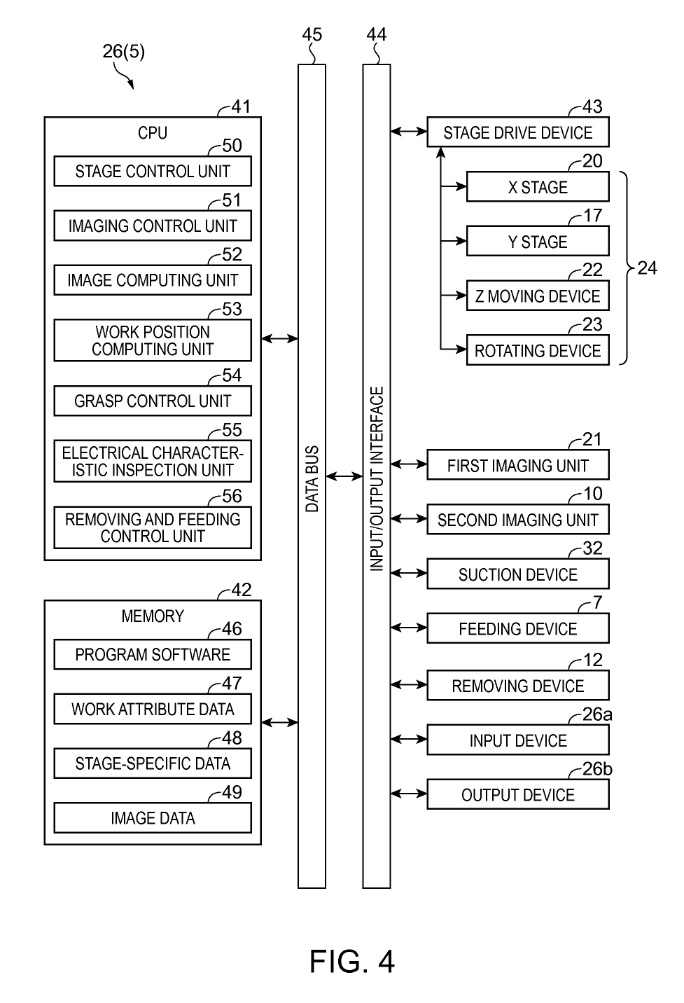

FIG. 4 is an electrical control block diagram of the electronic component inspection equipment. In FIG. 4, the electronic component inspection equipment 5 includes the control device 26 as the control unit that controls the operation of the electronic component inspection equipment 5. Further, the control device 26 includes a CPU (central processing unit) 41 that performs various kinds of arithmetic processing as a processor, and a memory 42 that stores various kinds of information.

A stage drive device 43, the first imaging unit 21, the second imaging unit 10, and the suction device 32 are connected to the CPU 41 via an input/output interface 44 and a data bus 45. Further, the feeding device 7, the removing device 12, the input device 26a, and the output device 26b are connected to the CPU 41 via the input/output interface 44 and the data bus 45.

The stage drive device 43 drives the X stage 20, the Y stage 17, the Z moving device 22, and the rotating device 23. The stage drive device 43 drives the stages and devices, and thereby, the grasping unit 25 can be moved to a desired position and a desired angle and stopped.

The memory 42 includes semiconductor memories such as a RAM and a ROM and external storage units such as a hard disc and a DVD-ROM in concept. Functionally, a storage area for storing program software 46 in which control procedures of the operation of the electronic component inspection equipment 5 are described and a storage area for storing work attribute data 47 as the shape of the electronic component 1 and coordinate data of the positions of the first electrodes 4a and the second electrodes 4b are set. In addition, a storage area for storing stage-specific data 48 as coordinate data of the positions of the first probes 27 and the second probes 28 of the grasping unit 25 and the third probes 36 and the relay terminals 37 of the inspection table 11 is set. Further, a storage area for storing image data 49 as data of images taken by the first imaging unit 21 and the second imaging unit 10 is set. Furthermore, a storage area that functions as a work area, a temporary file, or the like for the CPU 41 and other various storage areas are set.

The CPU 41 performs control for moving the electronic component 1 to a predetermined location and inspecting electrical characteristics according to the program software 46 stored within the memory 42. As a specific part that realizes the function, the CPU has a stage control unit 50 that controls moving and stopping of the X stage 20, the Y stage 17, the Z moving device 22, and the rotating device 23. The stage control unit 50 inputs position information output by the X stage 20, the Y stage 17, the Z moving device 22, and the rotating device 23. Further, the stage control unit 50 may detect the positions of the first imaging unit 21 and the grasping unit 25.

In addition, the CPU 41 has an imaging control unit 51 that gives instructions of imaging to the first imaging unit 21 and the second imaging unit 10. The imaging control unit 51 performs control of turning on and off of the illumination devices of the first imaging unit 21 and the second imaging unit 10. Further, the imaging control unit 51 performs focus adjustment of the first imaging unit 21 and the second imaging unit 10 and control of times for imaging. Thereby, the first imaging unit 21 and the second imaging unit 10 may take clear images.

Further, the CPU 41 has an image computing unit 52 that performs image processing on the images taken by the first imaging unit 21 and the second imaging unit 10. The image computing unit 52 removes noise from the taken images and computes predetermined characteristic amounts from the images. Specifically, for example, the unit computes the positions and inclinations of the first electrodes 4a and the second electrodes 4b. Furthermore, the CPU has a work position computing unit 53 that detects the positions of the first electrodes 4a using position information of the first imaging unit 21 detected by the stage control unit 50 and position data of the first electrodes 4a on the images detected by the image computing unit 52.

In addition, the CPU 41 has a grasp control unit 54 that controls whether the grasping unit 25 grasps or releases the electronic component 1 by driving of the electromagnetic valve 33. Further, the CPU has an electrical characteristic inspection unit 55 that inspects the electronic component 1 by inputting the electric signals output by the electronic component 1 in response to the electric signals output to the electronic component 1. Furthermore, the CPU has a removing and feeding control unit 56 that controls the operation of the feeding device 7 and the removing device 12.

Note that, in the embodiment, the respective functions are realized by program software using the CPU 41, however, in the case where the respective functions may be realized by a single electronic circuit (hardware) without using the CPU 41, the electronic circuit may be used. Further, within the electronic component inspection equipment 5, the part except the inspection table 11, the feeding device 7, the removing device 12, the electrical characteristic inspection unit 55, and the removing and feeding control unit 56 serves as an electronic component carrying device 5a. That is, the electronic component carrying device 5a is a device in the part that moves the electronic component 1, and the electronic component carrying device 5a with the additional function of the part that inspects the electrical characteristics forms the electronic component inspection equipment 5.

### Inspection Method

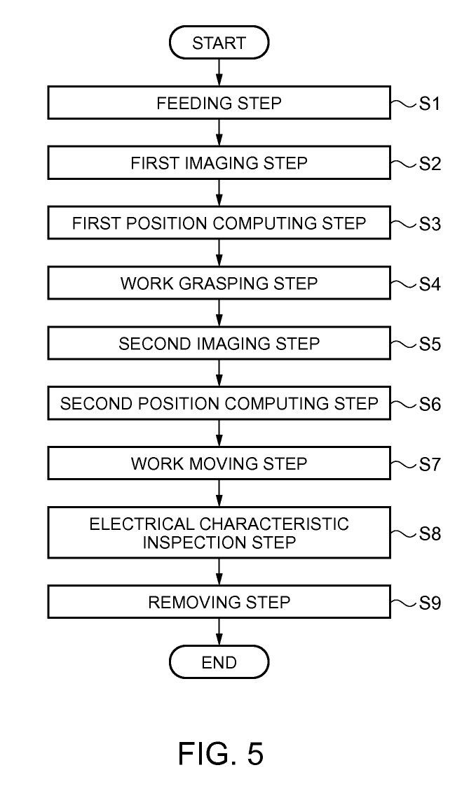

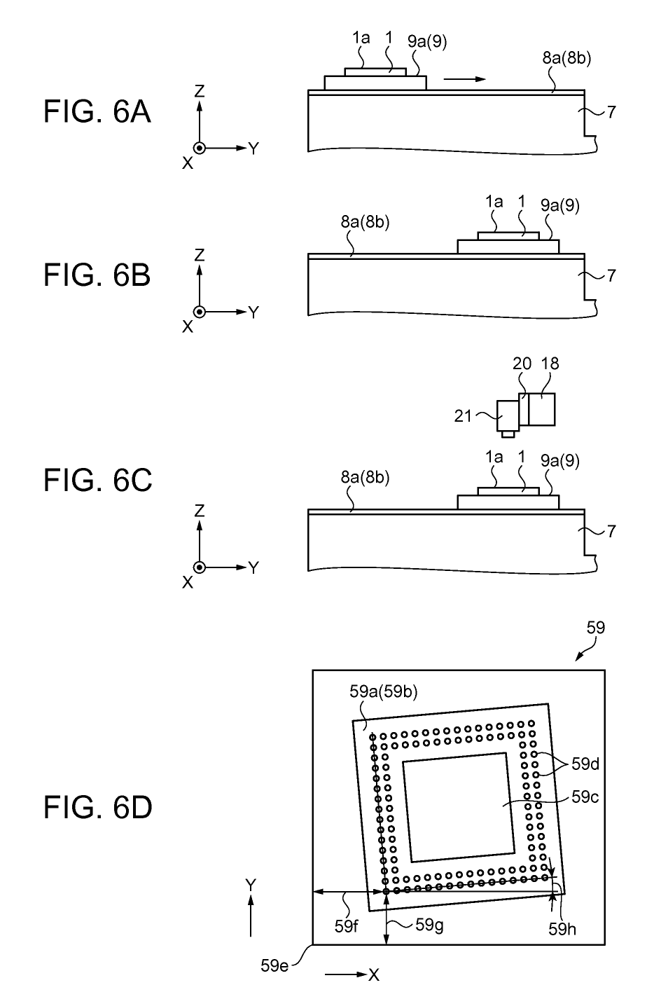

Next, an inspection method of inspecting electrical characteristics of the electronic component 1 using the above described electronic component inspection equipment 5 will be explained with reference to FIGS. 5 to 8C. FIG. 5 is a flowchart showing an inspection operation. FIGS. 6A to 8C are diagrams for explanation of an inspection method in the inspection operation.

In the flowchart shown in FIG. 5, step S1 corresponds to a feeding step. The step includes mounting a base material on the mounting surface and fixing it thereto. Then, the process moves to step S2. The step S2 corresponds to a first imaging step. The step includes imaging the first surface of the electronic component and forming the first image by the first imaging unit. Then, the process moves to step S3. The step S3 corresponds to a first position computing step. The step includes computing the position information of the first electrodes on the first surface using the first image by the control device. Then, the process moves to step S4. The step S4 corresponds to a work grasping step. The step includes grasping the electronic component with alignment of the relative positions of the first electrodes and the grasping unit. Then, the process moves to step S5.

The step S5 corresponds to a second imaging step. The step includes imaging the second surface of the electronic component and forming the second image by the second imaging unit. Then, the process moves to step S6. The step S6 corresponds to a second position computing step. The step includes computing the position information of the second electrodes on the second surface using the second image by the control device. Then, the process moves to step S7. The step S7 corresponds to a work moving step. The step includes activating the grasping unit 25 by the movable unit to move work to the inspection table 11 and placed thereon. Then, the process moves to step S8. The step S8 corresponds to an electrical characteristic inspection step. The step includes applying a current to the electronic component and inspecting the electrical characteristics of the electronic component using input and output signals. Then, the process moves to step S9. The step S9 corresponds to a removing step. The step includes activating the grasping unit 25 by the movable unit to move the work from the inspection table to the stage, and moving the electronic component to a location where the next step is performed by the stage. This step is the end of the inspection process of inspecting the electronic component.

Next, a carrying method and an inspection method of inspecting electrical characteristics of the electronic component 1 will be explained in detail in correspondence with the steps shown in FIG. 5 using FIGS. 6A to 8C. FIGS. 6A and 6B correspond to the feeding step of step S1. As shown in FIG. 6A, at step S1, the stage 9 waits at the left side in the drawing. Then, the operator mounts the electronic component 1 on the mounting surface 9a of the stage 9. The mounting of the electronic component 1 is not only by a human but also by a feeding robot or processing equipment. The electronic component 1 is mounted with the first surface 1a directed upward in the drawing. Then, the removing and feeding control unit 56 activates the suction-type substrate chuck mechanism to fix the electronic component 1 to the mounting surface 9a.

Next, as shown in FIG. 6B, the removing and feeding control unit 56 drives the feeding device 7 to move the stage 9 along the guide rails 8a, 8b to a predetermined position at the right side in the drawing. The first imaging unit 21 and the grasping unit 25 may move to a location above where the stage 9 has moved in the drawing.

FIG. 6C corresponds to the first imaging step of step S2. As shown in FIG. 6C, at step S2, the stage control unit 50 allows the stage drive device 43 to drive the movable part 24 and move the first imaging unit 21 to a position opposed to the electronic component 1. Then, the imaging control unit 51 allows the first imaging unit 21 to image the first surface 1a of the electronic component 1.

FIG. 6D corresponds to the first imaging step of step S2 and the first position computing step of step S3. As shown in FIG. 6D, the first imaging unit 21 forms a first image 59 obtained by imaging of the electronic component 1. In the first image 59, an electronic component image 59a, a substrate image 59b, a semiconductor chip image 59c, and first electrode images 59d respectively corresponding to the electronic component 1, the substrate 2, the semiconductor chip 3, the first electrodes 4a are formed. The first image 59 is represented by shading of pixels arranged in a lattice pattern. The number of pixels is determined by the performance of the first imaging unit 21 and not particularly limited. In the embodiment, for example, the numbers of longitudinal and lateral pixels are 2048×2048.

At step S3, the image computing unit 52 computes and detects the positions and the inclination of the first electrode images 59d. In the first image 59, the lower left corner in the drawing is set to an origin 59e of the image. Further, the rightward direction in the drawing is set to an X direction and the upward direction in the drawing is set to a Y direction. The image computing unit 52 computes the position information of the first electrode image 59d in the position nearest the origin 59e. Specifically, the unit computes the number of X pixels 59f as the number of pixels in the X direction and the number of Y pixels 59g as the number of pixels in the Y direction between the origin 59e and the first electrode images 59d. Then, the image computing unit 52 computes a first electrode angle 59h as an angle formed by the direction in which the first electrode images 59d are arranged and the X direction. In other words, the image computing unit 52 computes the position information of the first surface 1a.

The X stage 20, the Y stage 17, the Z moving device 22, and the rotating device 23 are provided with scales that respectively detect positions. The scale includes an encoder in which marks are formed and a sensor that detects the marks, for example, and may detect the position of the movable unit. The stage control unit 50 can detect the position of the first imaging unit 21 using the position information output by the scales of the respective devices. Further, the work position computing unit 53 detects the positions of the first electrodes 4a and the angle with respect to the X direction using the position information of the first electrode images 59d detected by the image computing unit 52.

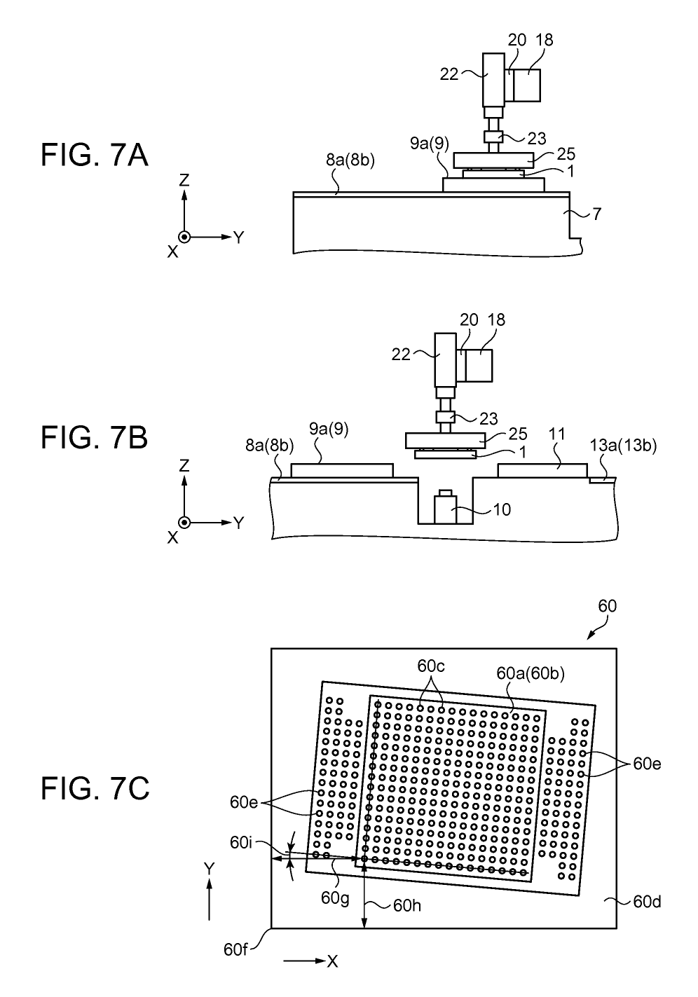

FIG. 7A corresponds to the work grasping step of step S4. As shown in FIG. 7A, at step S4, the stage control unit 50 allows the stage drive device 43 to drive the movable unit 24 and move the grasping unit 25 to a location opposed to the electronic component 1. In this regard, the stage control unit 50 controls the movable unit 24 so that the first probes 27 may be superimposed on the first electrodes 4a in the plan view of the XY plane. Further, the Z moving device 22 presses the grasping unit 25 against the electronic component 1 and the grasp control unit 54 activates the suction device 32. Thereby, the electronic component 1 is suctioned by the suction unit 30 of the grasping unit 25. That is, the electronic component inspection equipment 5 brings the relative positions between the grasping unit 25 and the first surface 1a into predetermined relative positions using the position information of the first surface 1a and grasps the electronic component 1.

FIG. 7B corresponds to the second imaging step of step S5. As shown in FIG. 7B, at step S5, the stage control unit 50 allows the stage drive device 43 to drive the movable unit 24 and move the electronic component 1 to a position opposed to the second imaging unit 10. Then, the imaging control unit 51 allows the second imaging unit 10 to image the second surface 1b of the electronic component 1.

FIG. 7C corresponds to the second imaging step of step S5 and the second position computing step of step S6. As shown in FIG. 7C, the second imaging unit 10 forms a second image 60 obtained by imaging of the electronic component 1. In the second image 60, an electronic component image 60a, a substrate image 60b, second electrode images 60c, a grasping unit image 60d, second probe images 60e respectively corresponding to the electronic component 1, the substrate 2, the second electrodes 4b, the grasping unit 25, and the second probes 28 are formed. The second image 60 is represented by shading of pixels arranged in a lattice pattern like the first image 59. The number of pixels of the second image 60 is the same as that of the first image 59.

At step S6, the image computing unit 52 computes and detects the positions and the inclination of the second electrode images 60c. In other words, the image computing unit 52 computes the position information of the second surface 1b. In the second image 60, the lower left corner in the drawing is set to an origin 60f of the image. Further, the rightward direction in the drawing is set to an X direction and the upward direction in the drawing is set to a Y direction. The image computing unit 52 computes the position information of the second electrode image 60c in the position nearest the origin 60f. Specifically, the unit computes the number of X pixels 60g as the number of pixels in the X direction and the number of Y pixels 60h as the number of pixels in the Y direction between the origin 60f and the second electrode images 60c. Then, the image computing unit 52 computes a second electrode angle 60i as an angle formed by the direction in which the second electrode images 60c are arranged and the X direction.

The X stage 20, the Y stage 17, the Z moving device 22, and the rotating device 23 are provided with scales that respectively detect positions. The stage control unit 50 can detect the position of the grasping unit 25 using the position information output by the scales of the respective devices. Further, the work position computing unit 53 detects the positions of the second electrodes 4b and the angle with respect to the X direction using the position information of the second electrode images 60c detected by the image computing unit 52.

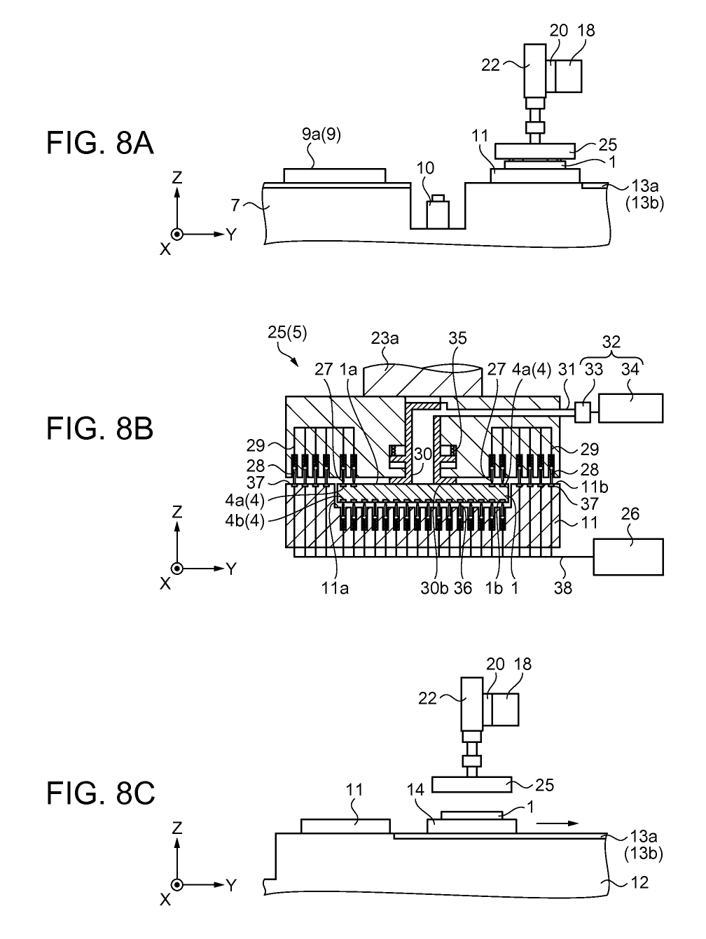

FIG. 8A corresponds to the work moving step of step S7. As shown in FIG. 8A, at step S7, the stage control unit 50 drives the stage drive device 43 to move the grasping unit 25 to a location opposed to the inspection table 11. Then, the stage control unit 50 drives the Z moving device 22 to press the grasping unit 25 against the inspection table 11.

FIG. 8B corresponds to the work moving step of step S7 and the electrical characteristic inspection step of step S8. As shown in FIG. 8B, the stage control unit 50 controls the movable unit 24 so that the electronic component 1 may be put in the recess part 11a of the inspection table 11 and the second electrodes 4b and the third probes 36 may be brought into contact. At step S6, the work position computing unit 53 has detected the positions of the second electrodes 4b with respect to the grasping unit 25. Further, the position data of the third probes 36 has been stored as stage-specific data 48 in the memory 42. The stage control unit 50 computes the relative positions between the second electrodes 4b and the third probes 36 and performs alignment with high positional accuracy. That is, the electronic component inspection equipment 5 moves the second surface 1b to a predetermined position using the position information of the second surface 1b.

Under the condition that the suction device 32 is activated and the first surface 1a is suctioned to the suction surface 30b, the Z moving device 22 presses the electronic component 1 against the inspection table 11. Thereby, the spring 35 contracts and the suction unit 30 moves toward the grasping unit 25. Then, the first probes 27 are pressed against the first electrodes 4a into electrical contact and the second probes 28 are pressed against the relay terminals 37 into electrical contact. Further, the third probes 36 are pressed against the second electrodes 4b into electrical contact.

The first electrodes 4a connect to the first probes 27, the first probes 27 connect to the second probes 28 via the wires 29. The second probes 28 connect to the relay terminals 37 and the relay terminals 37 connect to the control device 26 via the wires 38. Therefore, the control device 26 and the first electrodes 4a are conducted so that predetermined electric signals may be transmitted.

The second electrodes 4b connect to the third probes 36 and the third probes 36 connect to the control device 26 via the wires 38. Therefore, the control device 26 and the second electrodes 4b are conducted so that predetermined electric signals may be transmitted. Thereby, the control device 26 is conducted to the electrodes 4 of the first electrodes 4a and the second electrodes 4b, and electric signals may be transmitted.

At step S8, the electrical characteristic inspection unit 55 outputs the predetermined electric signals to the electrodes 4 according to the program software 46. Further, the electronic component 1 inputs the electric signals, operates, and outputs the electric signals to the electrodes 4. Then, the control device 26 inputs the electric signals output to the electrodes 4. The control device 26 analyzes the input electric signals and performs inspection as to whether or not the electronic component 1 has electrically performed a predetermined operation. Then, the electrical characteristic inspection unit 55 determines whether the electronic component 1 is a defective product or non-defective product, and stores the determination result as the work attribute data 47 in the memory 42.

FIG. 8C corresponds to the removing step of step S9. As shown in FIG. 8C, at step S9, with the electronic component 1 suctioned to the grasping unit 25, the stage control unit 50 drives the Z moving device 22 to raise the grasping unit 25. Then, the stage control unit 50 drives the movable unit 24 to move the grasping unit 25 to a location opposed to the stage 14. Subsequently, the grasp control unit 54 drives the suction device 32 to release the suction of the electronic component 1 in the grasping unit 25. As a result, the electronic component 1 is mounted on the stage 14.

Subsequently, the stage 14 moves to the right side in the drawing and the stage 14 carries the electronic component 1 to a location where the next step is performed. This step is the end of the inspection process of inspecting the electronic component. Note that, in the process, steps S2 to S7 are the carrying process and the method performed in the process corresponds to the electronic component carrying method.

As described above, according to the embodiment, there are the following advantages.

(1) According to the embodiment, the first imaging unit 21 images the first surface 1a of the electronic component 1 to form the first image 59. The image computing unit 52 and the work position computing unit 53 detect the position of the first surface 1a using the first image 59. Further, the stage control unit 50 controls the movable unit 24 and the movable unit 24 moves the grasping unit 25. Furthermore, the grasping unit 25 grasps the electronic component 1 so that the first electrodes 4a and the first probes 27 may be brought into contact. The work position computing unit 53 detects the position of the first surface 1a and the stage control unit 50 controls the position of the grasping unit 25, and thus, the electronic component carrying device 5a may align the relative positions with high positional accuracy between the grasping unit 25 and the first surface 1a and allow the grasping unit 25 to grasp the electronic component 1.

(2) According to the embodiment, the imaging control unit 51 controls the second imaging unit 10 and the second imaging unit 10 images the second surface 1b of the electronic component 1 to form the second image 60. The image computing unit 52 and the work position computing unit 53 recognize the position of the second surface 1b using the second image 60. Further, the image computing unit 52 controls the operation of the movable unit 24 to move the second surface 1b to the position opposed to the inspection table 11. The control device 26 detects and moves the position of the second surface 1b, and thus, the second surface 1b may be moved to the position opposed to the inspection table 11 with high positional accuracy. Therefore, the electronic component carrying device 5a may move the second surface 1b to the position opposed to the inspection table 11 with high positional accuracy.

(3) According to the embodiment, the first imaging unit 21 images the first surface 1a and the second imaging unit 10 images the second surface 1b. Therefore, the first imaging unit 21 may be positioned in the location where to easily image the first surface 1a, and the second imaging unit 10 may be positioned in the location where to easily image the second surface 1b. Thus, the first surface 1a and the second surface 1b may be easily imaged.

### Second Embodiment

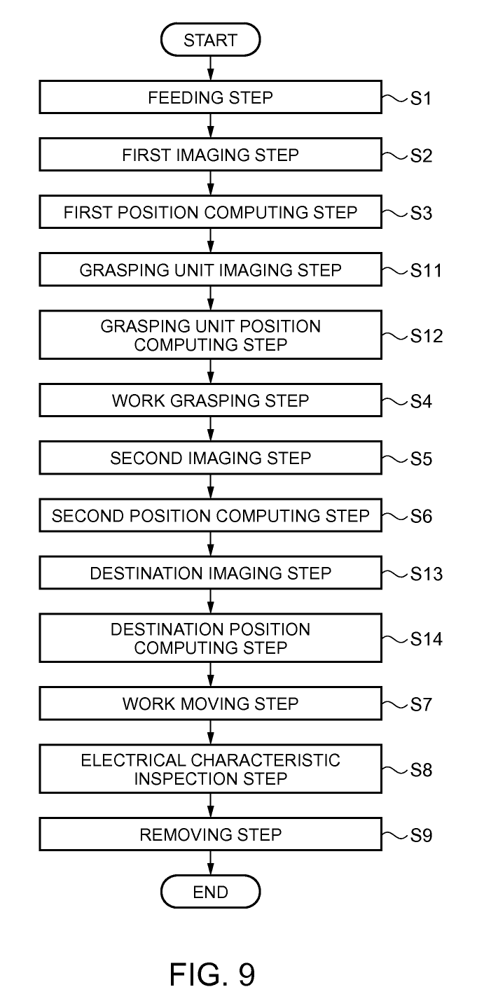

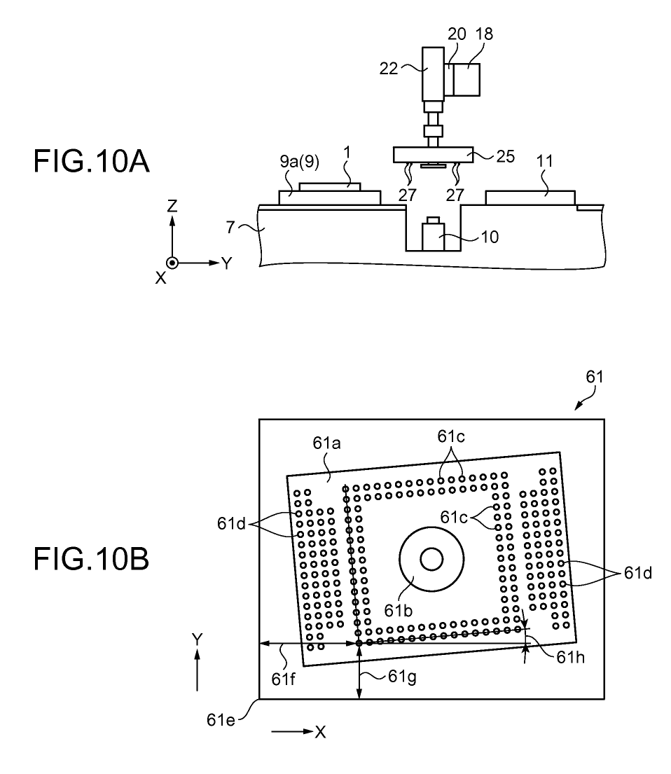

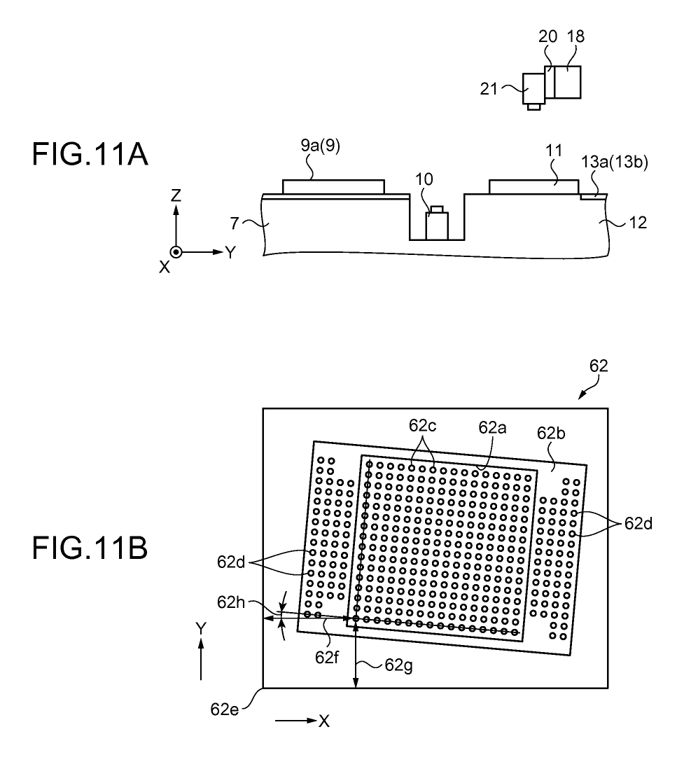

Next, one embodiment of a carrying method and an inspection method of the electronic component using the electronic component inspection equipment will be explained using FIGS. 9 to 11B. FIG. 9 is a flowchart showing an inspection operation, and FIGS. 10A to 11B are diagrams for explanation of an inspection method in the inspection operation. The embodiment is different from the first embodiment in that an imaging unit images a grasping unit and an inspection table and detects their positions. The explanation of the same configuration as that of the first embodiment will be omitted.

That is, in the embodiment, as shown in FIG. 9, step S11 and step S12 are added between the first position computing step of step 3 and the work grasping step of step 4. The steps S1 to S3 are the same as those of the first embodiment and their explanation will be omitted. The process moves to step S11 after step S3. The step S11 corresponds to a grasping unit imaging step. The step includes imaging the grasping unit by the imaging unit. Then, the process moves to step S12. The step S12 corresponds to a grasping unit position computing step. The step includes computing and detecting the position of the grasping unit by the image computing unit. The process moves to step S4.

Further, step S13 and step S14 are added between the second position computing step of step 6 and the work moving step of step 7. The steps S4 to S6 are the same as those of the first embodiment and their explanation will be omitted. The process moves to step S13 after step S6. The step S13 corresponds to a destination imaging step. The step includes imaging the inspection table by the imaging unit. Then, the process moves to step S14. The step S14 corresponds to a destination position computing step. The step includes computing and detecting the position of the inspection table by the image computing unit. The process moves to step S7. The steps S7 to S9 are nearly the same as those of the first embodiment and their explanation will be omitted.

Next, a carrying method and an inspection method of inspecting electrical characteristics of the electronic component 1 will be explained in detail with reference to FIGS. 10A, 10B, 11A, and 11B in correspondence with the steps shown in FIG. 9. The explanation of the steps nearly the same as those of the first embodiment will be omitted, and step S11, step S12, step S13, and step S14 will be explained. FIG. 10A corresponds to the grasping unit imaging step of step S11. As shown in FIG. 10A, at step S11, the stage control unit 50 allows the stage drive device 43 to drive the movable part 24 and move the grasping unit 25 to a location opposed to the second imaging unit 10. Then, the imaging control unit 51 allows the second imaging unit 10 to image the grasping unit 25.

FIG. 10B corresponds to the grasping unit imaging step of step S11 and the grasping unit position computing step of step S12. As shown in FIG. 10B, the second imaging unit 10 forms a grasping unit image 61 obtained by imaging of the grasping unit 25. In the grasping unit image 61, a grasping surface image 61a, a suction unit image 61b, first probe images 61c, and second probe images 61d respectively corresponding to the grasping surface 25b, the suction unit 30, the first probes 27, and the second probes 28 are formed. The grasping unit image 61 is represented by shading of pixels arranged in a lattice pattern. The number of pixels is the same as that of the first image 59, but not particularly limited. In the embodiment, for example, the numbers of longitudinal and lateral pixels are 2048×2048.

At step S12, the image computing unit 52 computes the positions and the inclination of the first probe images 61c. In the grasping unit image 61, the lower left corner in the drawing is set to an origin 61e of the image. Further, the rightward direction in the drawing is set to an X direction and the upward direction in the drawing is set to a Y direction. The image computing unit 52 computes the position information of the first probe image 61c in the position nearest the origin 61e. Specifically, the unit computes the number of X pixels 61f as the number of pixels in the X direction and the number of Y pixels 61g as the number of pixels in the Y direction between the origin 61e and the first probe images 61c. Then, the image computing unit 52 computes a first probe angle 61h as an angle formed by the direction in which the first probe images 61c are arranged and the X direction. In other words, the image computing unit 52 computes the position information of the grasping unit 25.

The position of the second imaging unit 10 on the base 6 has been known. The stage control unit 50 has fixed the grasping unit 25 in a predetermined position and the second imaging unit 10 has imaged the grasping unit 25. Therefore, the position of the grasping unit 25 with respect to the base 6 has also been known. Further, the work position computing unit 53 detects the positions of the first probes 27 and the angle with respect to the X direction using the position information of the first probe images 61c detected by the image computing unit 52. The CPU 41 stores the detected information on the positions of the first probes 27 and the angle with respect to the X direction as stage-specific data 48 in the memory 42. Then, at the work grasping step of step S4, the control device 26 controls the position of the grasping unit 25 using the position information of the first surface 1a detected at step S3 and the position information of the first probes 27 detected at step S12. Then, the control device 26 aligns the relative positions to bring the first electrodes 4a and the first probes 27 into contact and allows the grasping unit 25 to grasp the electronic component 1.

FIG. 11A corresponds to the destination imaging step of step S13. As shown in FIG. 11A, at step S13, the stage control unit 50 allows the stage drive device 43 to drive the movable part 24 and move the first imaging unit 21 to a location opposed to the inspection table 11. Then, the imaging control unit 51 allows the first imaging unit 21 to image the inspection table 11.

FIG. 11B corresponds to the destination imaging step of step S13 and the destination position computing step of step S14. As shown in FIG. 11B, the first imaging unit 21 forms an inspection table image 62 obtained by imaging of the inspection table 11. In the inspection table image 62, a recess part image 62a, an upper surface image 62b, third probe images 62c, and relay terminal images 62d respectively corresponding to the recess part 11a, the upper surface 11b, the third probes 36, and the relay terminals 37 are formed. The inspection table image 62 is represented by shading of pixels arranged in a lattice pattern. The number of pixels is the same as that of the first image 59, but not particularly limited. In the embodiment, for example, the numbers of longitudinal and lateral pixels are 2048×2048.

At step S14, the image computing unit 52 computes and detects the positions and the inclination of the third probe images 62c. In the inspection table image 62, the lower left corner in the drawing is set to an origin 62e of the image. Further, the rightward direction in the drawing is set to an X direction and the upward direction in the drawing is set to a Y direction. The image computing unit 52 computes the position information of the third probe image 62c in the position nearest the origin 62e. Specifically, the unit computes the number of X pixels 62f as the number of pixels in the X direction and the number of Y pixels 62g as the number of pixels in the Y direction between the origin 62e and the third probe images 62c. Then, the image computing unit 52 computes a third probe angle 62h as an angle formed by the direction in which the third probe images 62c are arranged and the X direction. In other words, the image computing unit 52 computes the position information of the inspection table 11 as a location to move.

The X stage 20, the Y stage 17, the Z moving device 22, and the rotating device 23 are provided with scales that respectively detect positions. The stage control unit 50 can detect the position of the first imaging unit 21 using the position information output by the scales of the respective devices. Further, the work position computing unit 53 detects the positions of the third probes 36 and the angle with respect to the X direction using the position information of the third probe images 62c detected by the image computing unit 52. The CPU 41 stores the detected information on the positions of the third probes 36 and the angle with respect to the X direction as stage-specific data 48 in the memory 42. Then, at the work moving step of step S7, the control device 26 controls the position of the grasping unit 25 using the position information of the second surface 1b detected at step S6 and the position information of the inspection table 11 detected at step S14. Then, the control device 26 aligns the relative positions to bring the second electrodes 4b and the third probes 36 into contact and presses the electronic component 1 against the inspection table 11. Note that, in the process, steps S2 to S7 are the carrying process and the method performed in the process corresponds to the electronic component carrying method.

As described above, according to the embodiment, there are the following advantages.

(1) According to the embodiment, the second imaging unit 10 images the grasping unit 25. Thereby, the control device 26 recognizes the position of the grasping unit 25 in addition to the position of the first surface 1a. Therefore, even when the actual position of the grasping unit 25 is changed with respect to the position of the grasping unit 25 that has been recognized by the control device 26, the electronic component 1 maybe grasped in response to the changed position. As a result, the grasping unit 25 may grasp the electronic component 1 with high positional accuracy.

(2) According to the embodiment, the first imaging unit 21 images the inspection table 11 as the location to move the electronic component 1. The control device 26 recognizes the positions of the third probes 36 on the inspection table 11 in addition to the position of the second surface 1b. Therefore, even when the positions of the third probes 36 are changed, the electronic component 1 may be moved in response to the changed position. As a result, the grasping unit 25 may bring the second electrodes 4b into contact with the third probes 36 with high positional accuracy.

### Third Embodiment

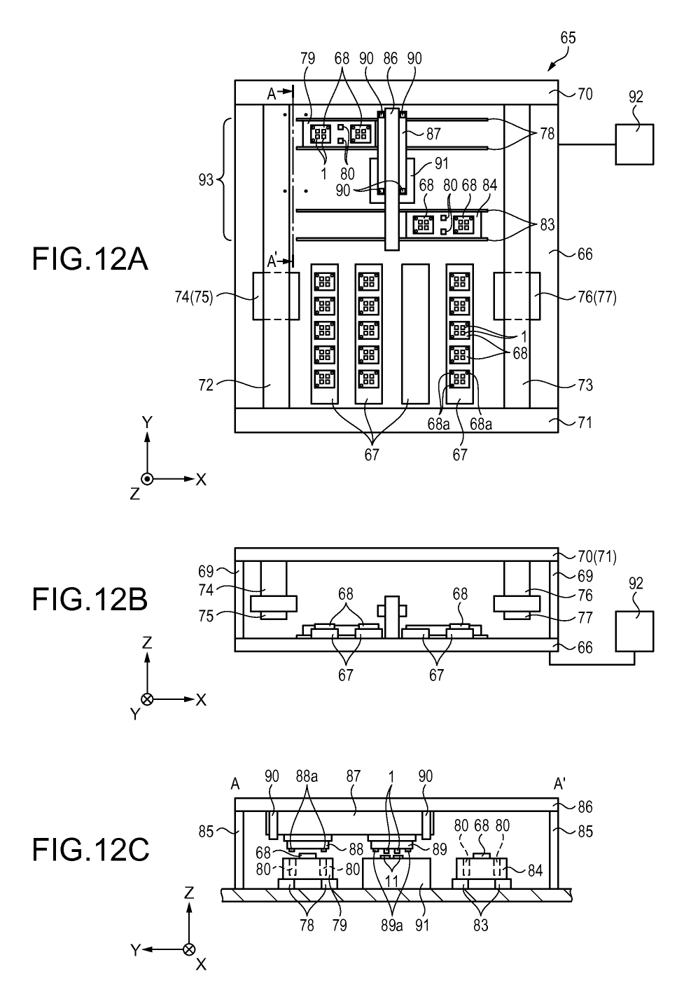

Next, one embodiment of a carrying device and an inspection equipment of the electronic component using the electronic component inspection equipment will be explained using FIGS. 12A to 12C. FIGS. 12A to 12C are diagrams showing inspection equipment of electronic components. FIG. 12A is a schematic plan view and FIG. 12B is a schematic side view. FIG. 12C is a schematic side sectional view of a main part showing the inspection stage. The embodiment is different from the first embodiment in that a movable unit is provided to shorten the time for carrying the electronic component. The explanation of the same configuration as that of the first embodiment will be omitted.

That is, in the embodiment, as shown in FIGS. 12A to 12C, inspection equipment 65 includes a base 66 having a rectangular shape. The direction in which the orthogonal two sides of the base 66 extend in the plan view of the base 66 are referred to as “X direction” and “Y direction” and the vertical direction is referred to as “−Z direction”. Four belt conveyers 67 elongated in the Y direction are provided at the −Y direction side on the base 66, and square trays 68 are arranged in the Y direction on the belt conveyers 67. Three marks 68a are provided on the tray 68 and four electronic components 1 are mounted thereon. Further, the electronic components 1 are arranged so that the first electrodes 4a of the electronic components 1 may be located in predetermined positions with respect to the marks 68a.

In four corners of the base 66, support columns 69 are respectively stood. A bridge member 70 extending in the X direction is bridged over the two support columns 69 located at ends in the Y direction, and a bridge member 71 extending in the X direction is bridged over the two support columns 69 located at ends in the −Y direction. Rails extending in the X direction are provided on the surfaces of the bridge member 70 and the bridge member 71 at the base 66 side. Further, a feeding X stage 72 and a removing X stage 73 having prismatic column shapes elongated in the Y direction are provided over the rails of the bridge member 70 and the bridge member 71. The feeding X stage 72 and the removing X stage 73 can reciprocate in the X direction along the rails.

Rails extending in the Y direction are provided on the surface of the feeding X stage 72 at the base 66 side. Further, a feeding Y stage 74 is provided over the rails of the feeding X stage 72, and the feeding Y stage 74 can reciprocate in the Y direction along the rails. A feeding and grasping unit 75 is provided at the base 66 side of the feeding Y stage 74, and the feeding Y stage 74 includes a direct-acting mechanism of moving the feeding and grasping unit 75 upward and downward. The feeding X stage 72 and the feeding Y stage 74 move the feeding and grasping unit 75, and the feeding and grasping unit 75 suctions and releases the trays 68. Thereby, the inspection equipment 65 can move the trays 68 on the belt conveyers 67.

Rails extending in the Y direction are provided on the surface of the removing X stage 73 at the base 66 side. Further, a removing Y stage 76 is provided over the rails of the removing X stage 73, and the removing Y stage 76 can reciprocate in the Y direction along the rails. A removing and grasping unit 77 is provided at the base 66 side of the removing Y stage 76, and the removing Y stage 76 includes a direct-acting mechanism of moving the removing and grasping unit 77 upward and downward. The removing X stage 73 and the removing Y stage 76 move the removing and grasping unit 77, and the removing and grasping unit 77 suctions and releases the trays 68. Thereby, the inspection equipment 65 can move the trays 68 onto the belt conveyers 67.

A pair of first rails 78 extending in the X direction are provided on the base 66 at the bridge member 70 side in the Y direction. A first shuttle 79 having a direct-acting mechanism is provided on the first rails 78, and the first shuttle 79 reciprocates in the X direction along the first rails 78. Two second imaging units 80 as imaging units directed in the Z direction are provided on the first shuttle 79. On the first shuttle 79, two locations on which the trays 68 are mounted are set in the X direction with the second imaging units 80 in between.

A pair of second rails 83 extending in the X direction are provided on the base 66 at the belt conveyer 67 side between the first shuttle 79 and the belt conveyers 67. A second shuttle 84 having a direct-acting mechanism is provided on the second rails 83, and the second shuttle 84 reciprocates in the X direction along the second rails 83. Two second imaging units 80 directed in the Z direction are provided on the second shuttle 84. On the second shuttle 84, two locations on which the trays 68 are mounted are set in the X direction with the second imaging units 80 in between.

A pair of support columns 85 are stood at the Y direction side of the first rails 78 and the −Y direction side of the second rails 83 on the base 66. The pair of support columns 85 are located at the centers of the first rails 78 and the second rails 83 in the X direction. A bridge member 86 extending in the Y direction is bridged over the support columns 85 and rails extending in the Y direction are provided on the surface of the bridge member 86 at the base 66 side. Further, an inspection stage 87 having a rectangular parallelepiped shape elongated in the Y direction is provided over the rails of the bridge member 86. The inspection stage 87 can reciprocate in the Y direction along the rails. The first shuttle 79, the second shuttle 84, and the inspection stage 87 form a movable unit.

A first inspection grasping unit 88 as a grasping unit and a second inspection grasping unit 89 as a grasping unit are provided at the base 66 side of the inspection stage 87. Marks 88a are provided on the first inspection grasping unit 88 and marks 89a are provided on the second inspection grasping unit 89. The inspection stage 87 includes a direct-acting mechanism of moving the first inspection grasping unit 88 upward and downward and a rotating mechanism of rotating the first inspection grasping unit 88. Similarly, the inspection stage 87 includes a direct-acting mechanism of moving the second inspection grasping unit 89 upward and downward and a rotating mechanism of rotating the second inspection grasping unit 89.

Four first imaging units 90 as imaging units for imaging the trays 68 mounted on the first shuttle 79 and the second shuttle 84 are provided on the inspection stage 87. The first imaging units 90 and the second imaging units 80 form imaging units.

An inspection base 91 is provided between the first rails 78 and the second rails 83 on the base 66, and the inspection table 11 is provided on the inspection base 91. As is the case of the first embodiment, the third probes 36 and the relay terminals 37 are provided on the inspection table 11. Further, in the first inspection grasping unit 88 and the second inspection grasping unit 89, the first probes 27, the second probes 28, and the suction unit 30 are provided. A control device 92 as a control unit is provided at the X direction side of the base 66, and the control device 92 controls the operation of the inspection equipment 65 and the inspection of electrical characteristics. Furthermore, the first shuttle 79, the second shuttle 84, the inspection stage 87, the first inspection grasping unit 88, the second inspection grasping unit 89, the second imaging units 80, the first imaging units 90, the control device 92, etc. form an electronic component carrying device 93.

Next, the operation of the inspection equipment 65 will be explained. First, an operator mounts the electronic components 1 on the trays 68. In this regard, the operator mounts the electronic components 1 so that the first electrodes 4a may be located in predetermined positions with respect to the marks 68a. Subsequently, the feeding and grasping unit 75 grasps the trays 68 on the belt conveyers 67 and carries them onto the first shuttle 79 and the second shuttle 84. Chucks for positioning and fixing the trays 68 are provided on the first shuttle 79, and thereby, the trays 68 are fixed to the first shuttle 79.

Then, the control device 92 moves the first shuttle 79 and the inspection stage 87 to move the trays 68 to locations opposed to the first imaging units 90. Subsequently, the first imaging units 90 image the trays 68. The control device 92 detects the relative positions between the marks 68a and the electronic components 1 using the taken images. Thereby, the control device 92 recognizes the positions of the electronic components 1. Then, the first inspection grasping unit 88 grasps the electronic components 1. In this regard, because the control device 92 has recognized the positions of the electronic components 1, the first inspection grasping unit 88 may grasp the electronic components 1 so that the first probes 27 and the first electrodes 4a may contact each other.

Then, the control device 92 moves the first shuttle 79 and the inspection stage 87 to move the first inspection grasping unit 88 to a location opposed to the second imaging units 80. Further, the second imaging units 80 image the marks 88a and the electronic components 1. The control device 92 detects the relative positions between the marks 88a and the electronic components 1 using the taken images. Thereby, the control device 92 recognizes the positions of the electronic components 1. Then, the first inspection grasping unit 88 presses the electronic components 1 against the inspection table 11. In this regard, because the control device 92 has recognized the positions of the electronic components 1, the first inspection grasping unit 88 may press the electronic components 1 against the inspection table 11 so that the third probes 36 and the second electrodes 4b may contact each other.

With the electronic components 1 pressed against the inspection table 11, the control device 92 inspects the electrical characteristics of the electronic components 1. Then, the control device 92 carries the electronic components 1 from the inspection table 11 to the trays 68 on the first shuttle 79. Subsequently, the removing and grasping unit 77 grasps the trays 68 on the first shuttle 79 and carries them onto the belt conveyers 67.

Similarly, the second inspection grasping unit 89 grasps the electronic components 1 located on the trays 68 on the second shuttle 84 and carries them to the inspection table 11. Concurrently, the second inspection grasping unit 89 performs the same operation as the first inspection grasping unit 88. Thereby, the second inspection grasping unit 89 may grasp the electronic components 1 so that the first probes 27 and the first electrodes 4a may contact each other. Further, the second inspection grasping unit 89 may press the electronic components 1 against the inspection table 11 so that the third probes 36 and the second electrodes 4b may contact each other.

The first inspection grasping unit 88 and the second inspection grasping unit 89 are provided on the inspection stage 87. Thereby, the step at which the first inspection grasping unit 88 moves the electronic components 1 from the inspection table 11 to the trays 68 of the first shuttle 79 may be performed in parallel to the step at which the second inspection grasping unit 89 moves the electronic components 1 from the trays 68 of the second shuttle 84 to the inspection table 11. Therefore, the electronic components 1 may be carried with high productivity.

Further, while the first inspection grasping unit 88, the second inspection grasping unit 89, and the inspection table 11 perform inspection of the electrical characteristics of the electronic components 1, the feeding Y stage 74 may carry the trays 68 from the belt conveyers 67 to the first shuttle 79 or the second shuttle 84. Furthermore, while the feeding and grasping unit 75 carries the trays 68, the removing and grasping unit 77 may carry the trays 68 from the first shuttle 79 or the second shuttle 84 to the belt conveyers 67. Therefore, by performing plural steps in parallel, the electronic components 1 may be carried with high productivity.

As described above, according to the embodiment, there are the following advantages.

(1) According to the embodiment, the electronic component carrying device 93 images the first electrodes 4a and the second electrodes 4b of the electronic components 1 and detects the positions of the first electrodes 4a and the second electrodes 4b. Therefore, the electronic component carrying device 93 may bring the first probes 27 and the first electrodes 4a into contact with each other and brings the third probes 36 and the second electrodes 4b into contact with each other.

(2) According to the embodiment, the step at which the feeding and grasping unit 75 moves the trays 68 and inspects the electrical characteristics of the electronic components 1 and the step at which the removing and grasping unit 77 moves the trays 68 may be performed in parallel. Therefore, the electrical characteristics of the electronic components 1 may be inspected with high productivity.

Note that the embodiment is not limited to the above described embodiment, and various changes and improvements may be made. Modified examples will be described as below.

### Modified Example 1

In the first embodiment, two imaging units of the second imaging unit 10 and the first imaging unit 21 have been used, however, only one imaging unit may be used. The imaging unit may be moved to the location for imaging using a mechanism of moving the imaging unit. If an imaging unit with high resolution is used, manufacturing of the imaging unit is not easy. In this case, by providing only one imaging unit, the electronic component inspection equipment 5 may be manufactured with high productivity. Further, if the imaging unit may be easily manufactured, three or more imaging units may be provided. By limiting the locations imaged by the respective imaging units, imaging may be performed with high resolution.

### Modified Example 2

In the first embodiment, the movable unit 24 has moved the first imaging unit 21 and the grasping unit 25 and the second imaging unit 10 and the inspection table 11 have been fixed. The first imaging unit 21 and the grasping unit 25 may be fixed and the movable unit 24 may move the second imaging unit 10 and the inspection table 11. It is only necessary that the positions of the first electrodes 4a and the second electrodes 4b may be detected and the electronic components 1 may be grasped and carried onto the inspection table 11. In this case, the same advantage may be obtained.

### Modified Example 3

In the second embodiment, the grasping unit imaging step of step S11 and the grasping unit position computing step of step S12 have been performed subsequent to the first position computing step of step S3. A grasping unit recognizing and determining step may be inserted between step 3 and step S11. The grasping unit recognizing and determining step includes determining whether or not to perform step S11 and step S12. For example, step S11 and step S12 may be performed only when power of the electronic component inspection equipment 5 is turned on or an environmental change of a temperature or the like occurs. In addition, step S11 and step S12 may be performed when step S1 and step S2 are performed at a predetermined number of times. In this manner, by reducing the number of times of step S11 and step S12, the inspection may be performed with high productivity.

### Modified Example 4

In the second embodiment, the destination imaging step of step S13 and the destination position computing step of step S14 have been performed subsequent to the second position computing step of step S6. A destination recognizing and determining step may be inserted between step S6 and step S13. The destination recognizing and determining step includes determining whether or not to perform step S13 and step S14. For example, step S13 and step S14 may be performed only when power of the electronic component inspection equipment 5 is turned on or an environmental change of a temperature or the like occurs. In addition, step S13 and step S14 may be performed when step S1 and step S2 are performed at a predetermined number of times. In this manner, by reducing the number of times of step S13 and step S14, the inspection may be performed with high productivity.

The entire disclosure of Japanese Patent Application No. 2011-162900, filed Jul. 26, 2011 is expressly incorporated by reference herein.

What is claimed is:

1. An electronic component carrying device comprising:
an imaging unit that forms a first image by imaging a first surface of an electronic component having the first surface and a second surface and forms a second image by imaging the second surface;
a grasping unit that grasps the electronic component;
a movable unit that moves the grasping unit; and
a control unit that detects a position of the first surface using the first image, detects a position of the second surface using the second image, and controls the grasping unit and the movable unit,
wherein the grasping unit brings relative positions between the grasping unit and the first surface into predetermined relative positions and grasps the electronic component using information of the position of the first surface detected by the control unit, and the movable unit moves the second surface to a predetermined position using information of the position of the second surface detected by the control unit.

2. The electronic component carrying device according to claim 1, wherein the imaging unit images the grasping unit, the control unit detects a position of the grasping unit using an image of the grasping unit, the grasping unit brings the relative positions between the first surface and itself into the predetermined relative positions and grasps the electronic component using information of the position of the grasping unit detected by the control unit.

3. The electronic component carrying device according to claim 1, wherein the imaging unit images a location to move as a location to move the electronic component, the control unit detects a position of the location to move using an image of the location to move, and the grasping unit moves the second surface to the location to move using information of the position of the location to move detected by the control unit.

4. The electronic component carrying device according to claim 2, wherein the imaging unit images a location to move as a location to move the electronic component, the control unit detects a position of the location to move using an image of the location to move, and the grasping unit moves the second surface to the location to move using information of the position of the location to move detected by the control unit.

5. The electronic component carrying device according to claim 1, wherein the imaging unit includes a first imaging unit that images the first surface and a second imaging unit that images the second surface.

6. The electronic component carrying device according to claim 2, wherein the imaging unit includes a first imaging unit that images the first surface and a second imaging unit that images the second surface.

7. The electronic component carrying device according to claim 3, wherein the imaging unit includes a first imaging unit that images the first surface and a second imaging unit that images the second surface.

8. An electronic component carrying method of carrying an electronic component having a first surface and a second surface grasped by a grasping unit, the method comprising:
imaging the first surface and computing position information of the first surface;
bringing relative positions between the grasping unit and the first surface into predetermined relative positions and grasping the electronic component using the position information of the first surface;
imaging the second surface and computing position information of the second surface; and
moving the second surface to a predetermined position using the position information of the second surface.

9. The electronic component carrying method according to claim 8, before grasping the electronic component, further comprising:
imaging the grasping unit and computing position information of the grasping unit; and
bringing the relative positions between the grasping unit and the first surface into the predetermined relative positions and grasping the electronic component using the position information of the grasping unit in addition to the position information of the first surface.

10. The electronic component carrying method according to claim 8, before moving the second surface, further comprising:
imaging a location to move as a location to move the electronic component, and computing position information of the location to move; and
moving the second surface to a position of the location to move using the position information of the location to move in addition to the position information of the second surface.

11. The electronic component carrying method according to claim 9, before moving the second surface, further comprising:
imaging a location to move as a location to move the electronic component, and computing position information of the location to move; and
moving the second surface to a position of the location to move using the position information of the location to move in addition to the position information of the second surface.

12. An electronic component carrying device that carries an electronic component to an inspection table comprising:
an imaging unit that forms a first image by imaging a first surface of the electronic component having the first surface and a second surface and forms a second image by imaging the second surface;
a grasping unit that grasps the electronic component;
a movable unit that moves the grasping unit; and
a control unit that detects a position of the first surface using the first image, detects a position of the second surface using the second image, and controls the grasping unit and the movable unit,
wherein the imaging unit images the grasping unit and the inspection table.

13. The electronic component carrying device according to claim 12, wherein the imaging unit includes a first imaging unit and a second imaging unit, and
the first imaging unit images the first surface and the inspection table, the second imaging unit images the second surface and the grasping unit.
